(19) United States
(12) Patent Application Publication
(10) Pub. No.: US 2024/0308793 A1
(43) Pub. Date: Sep. 19, 2024

(54) LOCKING APPARATUS AND DRIVERLESS TRANSPORT VEHICLE

(71) Applicant: SEW-EURODRIVE GMBH & CO. KG, Bruchsal (DE)

(72) Inventors: Marc HAMMER, Stutensee (DE); Dirk DEGEN, Bruchsal (DE); Sascha JOCHEM, Lingenfeld (DE)

(73) Assignee: SEW-EURODRIVE GMBH & CO. KG, Bruchsal (DE)

(21) Appl. No.: 18/275,488

(22) PCT Filed: Jan. 18, 2022
(86) PCT No.: PCT/EP2022/025016

§ 371 Date: Aug. 2, 2023

(30) Foreign Application Priority Data
Feb. 2, 2021 (DE) 102021000494.9

(51) Int. Cl. B65G 69/00

(52) U.S. Cl. CPC B65G 69/003

(57) ABSTRACT

A locking apparatus for locking to a movable frame includes a base, a latching hook which is pivotable relative to the base about a pivot pin extending in a transverse direction between a locking position and an unlocking position, and a latching apparatus for blocking the latching hook on the base in the locking position. The latching hook has a latching portion and a control portion, and the latching portion has a capturing contour for receiving a profile of a frame in the locking position. The latching hook is arranged such that, when a locking force is applied to the control portion, the latching hook is pivoted from the unlocking position into the locking position, and the latching apparatus is configured and arranged such that the latching hook is blocked automatically by the latching apparatus when the locking position is reached, in which the latching apparatus comes into a blocking position. A driverless transport vehicle includes a drive device, an electrical energy store for supplying power to the drive device, and a control unit for controlling the drive device, at least one locking apparatus.

### FIELD OF THE INVENTION

The present invention relates to a locking apparatus for locking to a movable frame, e.g., including a base, a latching hook which can be pivoted relative to the base about a pivot pin extending in a transverse direction between a locking position and an unlocking position, and a latching apparatus for blocking the latching hook on the base in the locking position. The present invention also relates to a driverless transport vehicle, e.g., including at least one locking apparatus as described herein.

### BACKGROUND INFORMATION

Driverless transport vehicles can be used in various installations, for example, in supermarkets, industrial facilities, logistics centers, hospitals, and production plants. Driverless transport vehicles are used, for example, to transport objects, such as movable frames, within the respective installation.

Such a frame has one or more support surfaces arranged one above the other for holding goods. Such a frame also has a plurality of rotatable rollers, which are arranged below the support surfaces, and which are in contact with a floor on which the frame stands. The frame is movable by rollers.

To transport the frame by a driverless transport vehicle, the frame can be locked to the driverless transport vehicle by a locking apparatus. If the frame is located at a stationary workstation where, for example, goods located thereon are removed, the frame can be locked at the workstation by a locking apparatus to prevent the frame from rolling away unintentionally.

A device for securing loads is described in German Patent Document No. 203 02 929. The device includes a slide which is movable on a rail. The rail has latching recesses for receiving a latching element.

A device for securing containers and pallets on transport surfaces is described in German Patent Document No. 10 2012 021 450. Grooves are embedded in the transport surface, and a narrow frame is attached thereabove. Base frames of the containers are attachable to the frame.

### SUMMARY

Example embodiments of the present invention provide a locking apparatus for locking to a movable frame, which locking apparatus can be used at a stationary workstation as well as on a driverless transport vehicle. Example embodiments of the present invention provide a corresponding driverless transport vehicle.

A locking apparatus, according to example embodiments of the present invention, for locking to a movable frame includes a base, a latching hook which can be pivoted relative to the base about a pivot pin extending in a transverse direction between a locking position and an unlocking position, and a latching apparatus for blocking the latching hook on the base in the locking position. The latching hook has a latching portion and a control portion, and the latching portion has a capturing contour for receiving a profile of a frame in the locking position. The latching hook is arranged such that when a locking force is applied to the control portion, the latching hook is pivoted from the unlocking position into the locking position, and the latching apparatus is configured and arranged such that the latching hook is blocked automatically by the latching apparatus when the locking position is reached, in which the latching apparatus comes into a blocking position.

The frame can be locked by the locking apparatus on a stationary workstation where, for example, goods located thereon are removed, in order to prevent the frame from rolling away unintentionally. The frame is locked automatically by pushing it onto the locking apparatus; no additional manual operation of the locking apparatus is required for locking, thus saving process time.

According to example embodiments, the latching hook and the latching apparatus are arranged such that when the latching apparatus is moved out of the blocking position, when the latching apparatus blocks the latching hook in the locking position, and in the absence of a locking force on the control portion, the latching hook is pivoted from the locking position into the unlocking position. The frame can thus be unlocked by moving the latching apparatus out of the blocking position.

According to example embodiments, the latching portion extends at least approximately perpendicular to the control portion. This provides for a compact arrangement of the locking apparatus.

According to example embodiments, a pivoting movement of the latching hook from the locking position into the unlocking position is effected by a gravitational force acting on the latching hook, e.g., on the latching portion. Additional components, such as springs or drives, are thus not required, and the configuration of the locking apparatus is simplified.

According to example embodiments, a pivoting movement of the latching hook from the locking position into the unlocking position is effected by a spring force acting on the latching hook. The locking position can thus be used flexibly in different alignments. The alignment does not depend on the direction of gravity.

According to example embodiments, the latching portion has a landing surface which is arranged on a side of the capturing contour facing away from the control portion and which extends inclined to a longitudinal direction and inclined to a vertical direction. The landing surface allows a frame to be pushed in even when the latching hook is in the locking position. The profile of the frame slides along the landing surface over the capturing contour, falls into place behind the capturing contour, and is thus received by the capturing contour.

According to example embodiments, the control portion has a control contour which interacts with the latching apparatus such that during a pivoting movement of the latching hook from the unlocking position into the locking position, the latching apparatus is moved out of the blocking position.

For example, the control contour interacts with the latching apparatus such that, when the locking position is reached, the latching apparatus is moved into the blocking position. This causes the frame to be automatically locked by the locking apparatus.

According to example embodiments, the control portion has a bore which interacts with the latching apparatus such that, when the latching hook is in the locking position and the latching apparatus is in the blocking position, a latching pin of the latching apparatus engages in the bore. The latching pin engaging in the bore ensures that the latching hook is blocked in the locking position.

According to example embodiments, the latching apparatus is movable out of the blocking position and into the blocking position in the transverse direction, and the bore extends in the transverse direction. The frame can thus be unlocked by a translatory movement of the latching apparatus.

According to example embodiments, the latching apparatus can be moved out of the blocking position against a spring force. The latching apparatus is thus automatically moved into the blocking position by the spring force.

According to example embodiments, the latching hook has a sensor for detecting a profile of a frame. The sensor allows detection of whether a frame is locked to the locking apparatus and a corresponding message to a control unit.

A driverless transport vehicle according to example embodiments of the present invention includes a drive device, an electrical energy store for supplying power to the drive device, and a control unit for controlling the drive device, and at least one locking apparatus as described herein. The drive device includes, for example, an electric motor, a gearbox, and drive wheels. To transport a frame, the frame can be locked to the driverless transport vehicle by the locking apparatus.

Example embodiments of the present invention are explained in more detail below with reference to the appended schematic Figures.

### BRIEF DESCRIPTION OF THE DRAWINGS

FIG. 1 is a perspective view of a movable frame locked to a locking apparatus.

FIG. 2 is a side view of the locking apparatus in a locking position.

FIG. 3 is a side view of the locking apparatus in an unlocking position.

FIG. 4 is a top view of the locking apparatus in an unlocking position.

### DETAILED DESCRIPTION

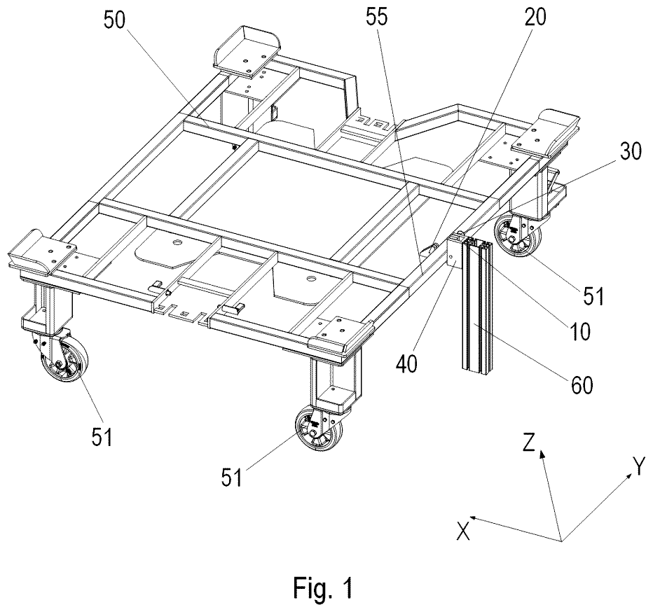

FIG. 1 is a perspective view of a movable frame 50 locked to a locking apparatus 10. The frame 50 is located on a flat floor, which extends perpendicular to a vertical direction Z. A transverse direction Y extends perpendicular to the vertical direction Z. A longitudinal direction X extends perpendicular to the vertical direction Z and perpendicular to the transverse direction Y.

The frame 50 includes a support surface extending perpendicular to the vertical direction Z. The support surface is used for receiving goods to be transported, for example, boxes or cartons. The support surface is formed from a number of profiles 55 which are joined together, for example, welded together. The profiles 55, e.g., profiles 55 arranged at the edge of the support surface, have a rectangular or square cross-section.

The frame 50 further includes four rotatable rollers 51. The rollers 51 are arranged below the support surfaces and are in contact with the floor. The rollers 51 can each be rotated about an axis of rotation which extends perpendicular to the vertical direction Z. The rollers 51 can also each be pivoted about a pivot pin, which extends in the vertical direction Z. The axis of rotation and the pivot pin of such a roller 51 do not intersect but are spaced from each other. By the rollers 51, the frame 50 is movable on the floor.

A locking apparatus 10 is attached to a column 60 extending from the floor in the vertical direction Z. The locking apparatus 10 includes a base 40, a latching hook 20, and a latching apparatus 30. The base 40 of the locking apparatus 10 is attached to the column 60. For locking the frame 50, the latching hook 20 of the locking apparatus 10 interacts with a profile 55 of the frame 50.

It is also possible to attach a locking apparatus 10 to a wall or vehicle. It is also possible to attach a locking apparatus 10 to a frame 50 so that a plurality of frames 50 can be locked to each other. For example, it is possible to attach a locking apparatus 10 to a driverless transport vehicle. Thus, frames can be transported by the driverless transport vehicle within a plant.

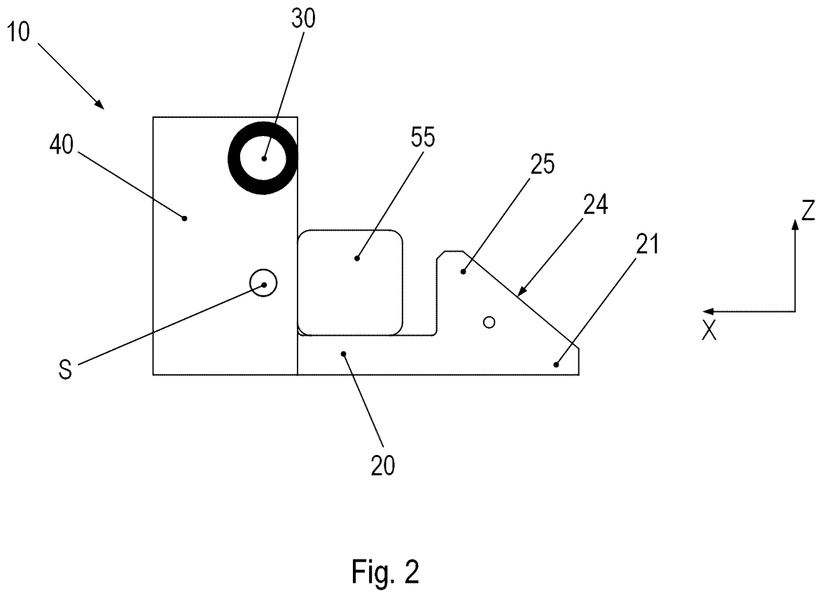

FIG. 2 is a side view of the locking apparatus 10 in a locking position. The latching hook 20 is pivotable relative to the base 40 about a pivot pin S extending in a transverse direction Y between the locking position illustrated and an unlocking position. The latching apparatus 30 is in the blocking position and blocks the latching hook 20 on the base 40 in the locking position.

The latching hook 20 has a latching portion 21 and a control portion 22. The latching portion 21 has a capturing contour 25 in which the profile 55 of the frame 50 is received in the locking position. The latching portion 21 extends at least approximately perpendicular to the control portion 22. In the locking position, the latching portion 21 extends in the longitudinal direction X, and the control portion 22 extends in the vertical direction Z.

The pivoting movement of the latching hook 20 from the locking position into the unlocking position is effected by a gravitational force acting on the latching hook 20, e.g., on the latching portion 21. Alternatively or additionally, it is possible to provide a spring so that the pivoting movement of the latching hook 20 from the locking position into the unlocking position is effected by a spring force acting on the latching hook 20.

The latching portion 21 has a landing surface 24 that extends inclined to a longitudinal direction X and inclined to a vertical direction Z. The landing surface 24 is arranged on a side of the capturing contour 25 facing away from the control portion 22.

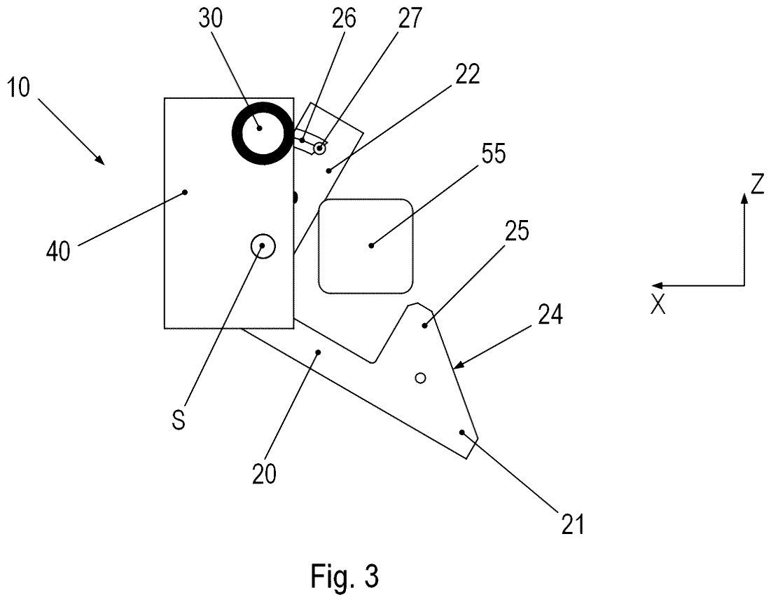

FIG. 3 is a side view of the locking apparatus 10 in an unlocking position. Compared to the position illustrated in FIG. 1, the latching hook 20 is pivoted about the pivot pin S relative to the base 40. The profile 55 of the frame 50 is released in the unlocked position. The latching apparatus 30 is in the blocking position. However, the latching apparatus 30 does not block the latching hook 20 in the unlocked position.

When the profile 55 of the frame 50 is pressed against the control portion 22 of the latching hook 20, a latching force is thereby applied to the control portion 22. The locking force acts in the longitudinal direction X towards the base. When the locking force is applied, the latching hook 20 is pivoted from the unlocking position into the locking position.

The control portion 22 has a bore 27 which interacts with a latching pin 32 of the latching apparatus 30. The bore 27 extends in the transverse direction Y. The latching apparatus 30 with the latching pin 32 is moveable in the transverse direction Y. The latching apparatus 30 is movable out of the blocking position against a spring force. In the absence of a counterforce, the latching apparatus 30 is moved into the blocking position by the spring force. With the latching hook 20 in the locking position and the latching apparatus 30 in the blocking position, the latching pin 32 engages in the bore 27.

The control portion 22 has a control contour 26. The control contour 26 is a surface extending from the bore 27 to an edge of the control portion 22, and extends inclined to the transverse direction Y. During a pivoting movement of the latching hook 20 from the unlocking position into the locking position, the latching pin 32 slides along the control contour 26. Thus, the latching apparatus 30 is moved out of the blocking position. When the locking position is reached, the latching pin 32 drops into the bore 27. This causes the latching apparatus 30 to move to the blocking position, and, in the locking position, the latching hook 20 is automatically blocked by the latching apparatus 30.

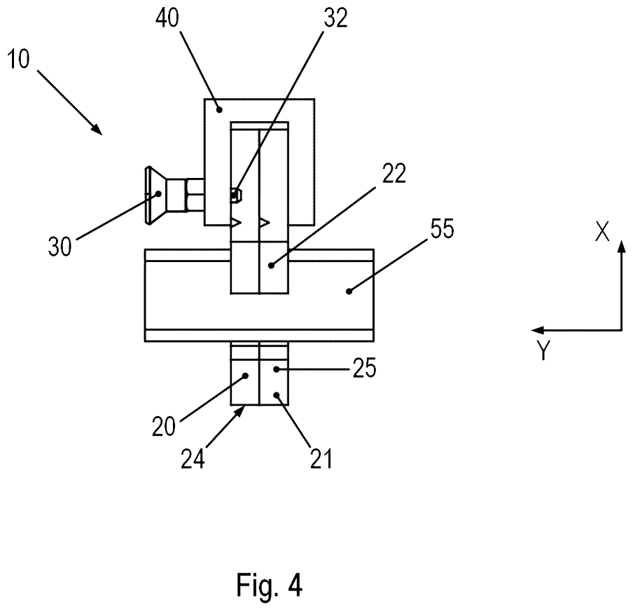

FIG. 4 is a top view of the locking apparatus 10 in an unlocking position. The latching apparatus 30 is in the blocking position, and the latching pin 32 protrudes into a cavity of the base 40 behind the control portion 22 of the latching hook 20. As mentioned above, by pulling in the transverse direction Y, the latching apparatus 30 is movable out of the blocking position against a spring force.

When the latching apparatus 30 is moved in this manner out of the blocking position, the latching pin 32 is pulled out of the bore 27. In the absence of a locking force on the control portion 22, the latching hook 20 is thus pivoted from the locking position into the unlocking position.

### LIST OF REFERENCE CHARACTERS

10 Locking apparatus
20 Latching hook
21 Latching portion
22 Control portion
24 Landing surface
25 Capturing contour
26 Control contour
27 Bore
30 Latching apparatus
32 Latching pin
40 Base
50 Frame
51 Roller
55 Profile
60 Column
S Pivot pin
x Longitudinal direction
Y Transverse direction
Z Vertical direction

1-13. (canceled)

14. A locking apparatus for locking to a movable frame, comprising:
a base;
a latch hook pivotable relative to the base about a pivot pin extending in a transverse direction between a locking position and an unlocking position; and
a latch apparatus adapted to block the latch hook on the base in the locking position;
wherein the latch hook includes a latch portion and a control portion, the latch portion including a capture contour adapted to receive a profile of the frame in the locking position;
wherein the latch hook is adapted to pivot from the unlocking position to the locking position in response to a locking force applied to the control portion; and
wherein the latch apparatus is adapted to move into a blocking position to automatically block the latch hook in response to the locking position being reached.

15. The locking apparatus according to claim 14, wherein the latch hook is adapted to pivot from the locking position to the unlocking position in response to the latching apparatus moving out of the blocking position, and in an absence of a locking force on the control portion.

16. The locking apparatus according to claim 14, wherein the latch portion extends at least approximately perpendicular to the control portion.

17. The locking apparatus according to claim 14, wherein the latch portion extends perpendicular to the control portion.

18. The locking apparatus according to claim 14, wherein the latch hook is adapted to pivot from the locking position to the locking position by a gravitational force acting on the latch hook and/or the latch portion.

19. The locking apparatus according to claim 14, wherein the latch hook is adapted to pivot from the locking position to the unlocking position by a spring force acting on the latch hook.

20. The locking apparatus according to claim 14, wherein the latch portion includes has a landing surface arranged on a side of the capture contour facing away from the control portion and extending inclined to a longitudinal direction and inclined to a vertical direction.

21. The locking apparatus according to claim 14, wherein the control portion includes a control contour adapted to interact with the latch apparatus to move the latch apparatus out of the blocking position during a pivot movement of the latch hook from the unlocking position into the locking position.

22. The locking apparatus according to claim 21, wherein the control contour is adapted to interact with the latch apparatus to move the latch apparatus into the blocking position in response to the locking position being reached.

23. The locking apparatus according to claim 14, wherein the control portion includes a bore adapted to interact with the latch apparatus to engage a latch pin of the latch apparatus into the bore in response to the latch hook being in the locking position and the latch apparatus being in the blocking position.

24. The locking apparatus according to claim 23, wherein the latch apparatus is movable in the transverse direction, and the bore extends in the transverse direction.

25. The locking apparatus according to claim 14, wherein the latch apparatus is movable out of the blocking position against a spring force.

26. The locking apparatus according to claim 14, wherein the latch hook includes a sensor adapted to detecting a profile of the frame.

27. A system, comprising:
a driverless transport vehicle, including:
a drive device;
an electrical energy store adapted to supply power to the drive device; and
a control unit adapted to control the drive device; and
at least one locking apparatus as recited in claim 14.

28. The system according to claim 27, wherein the vehicle includes a support surface adapted to receive goods to be transported by the vehicle.

29. The system according to claim 28, wherein the vehicle includes a plurality of rollers arranged below the support surface and adapted to roll on a floor, the rollers rotatable about a rotation axis parallel to the floor and pivotable about a pivot axis perpendicular to the floor.

30. The system according to claim 27, wherein the locking apparatus is attachable to a column that extends perpendicular to a floor on which the vehicle is movable.

31. The system according to claim 27, wherein the locking apparatus is attached to a column that extends perpendicular to a floor on which the vehicle is movable.

32. The system according to claim 28, wherein the support surface includes a plurality of profiles that are joined and/or welded together.

33. The system according to claim 28, wherein the profiles are arranged around a perimeter of the support surface.
